(19) United States
(12) Patent Application Publication
(10) Pub. No.: US 2022/0217942 A1
(43) Pub. Date: Jul. 14, 2022

(54) Drying and Brushing Apparatus and Method

(71) Applicants: Douglas McClain, Medina, OH (US); Nancy McClain, Medina, OH (US)

(72) Inventors: Douglas McClain, Medina, OH (US); Nancy McClain, Medina, OH (US)

(21) Appl. No.: 17/148,857

(22) Filed: Jan. 14, 2021

(51) Int. Cl. A01K 13/00; A46B 15/00; A46B 9/02; A46B 7/04; A46B 5/00; F26B 5/14; F26B 21/00

(52) U.S. Cl. CPC A01K 13/001; A46B 15/0051; A46B 9/023; A46B 7/046; A46B 2200/1093; A01K 13/002; F26B 5/14; F26B 21/001; A46B 5/0095

(57) ABSTRACT

Provided is an apparatus which simultaneously dries and brushes animals with hair or fur. A positive air pressure source is forced through a general air passageway configuration, comprising a tube, a handle member air passageway, a brush member air passageway, and an outward air aperture. A handle member, comprising a heat adjuster and airflow adjuster, connects to a brush member including an air aperture, a bristle base, and bristles. The bristle base is detachable from the brush member. A depressible prong mechanism is fastened to the handle member for repeated connection and disconnection of the handle member and the brush member. The detachable bristle base and the disconnection of the handle member from the brush member allows for effective apparatus cleaning which leads to more efficient animal drying.

### I. TECHNICAL FIELD

The present disclosure pertains to the field of drying and brushing apparatuses. More specifically, to drying and brushing animals with hair or fur.

### II. BACKGROUND

Many people own animals like dogs, cats, birds (i.e. pets), chickens, horses, and pigs as pets, farm animals, etc. In many cases, people take their animals outside to walk. In other cases, the animal lives outside. Some animals may get dirty when they are outside. For example, a dog may jump into a muddy pond. Afterward, the dog will need to be washed before it can enter the home. After washing the dog with soap and water, the next step is to drying the dog.

Unfortunately, drying a dog can be difficult. If the dog has long fur or hair, it can be difficult to remove the water from the fur or hair. For dogs with long hair, drying with a towel can mat down the dog's fur and make the dog look aesthetically unappealing.

Apparatuses such as air flow devices used to brush and dry the dog can become clogged by fur/hair, oil, and other matter after repeated use. After becoming clogged or blocked, it is difficult or impossible to clean the apparatus and remove the clogging matter.

Even if these devices do not get clogged, they at least have fur/hair, oil, and other matter may cling to the bristles and cover the apparatus' air holes. Once they are covered, the airflow is blocked and needs to be removed.

What is needed is an apparatus that can dry off an animal while simultaneously brushing the fur to make the animal look aesthetically appealing that is easily cleanable. Further, the apparatus should be easily cleanable and its air holes should not be prone to becoming clogged.

### II. SUMMARY

Provided in this disclosure is an apparatus including a positive pressure air source; a tube connecting the positive pressure air source, and a handle member; the handle member being connected to a brush member; the brush member further including a plurality of air apertures, a bristle base, and bristles. The air apertures include a plurality of air inlet ports and corresponding air outlet ports.

According to one aspect of the present disclosure, the air outlet ports surround the bristle base. The air outlet ports' location and shape leads to more efficiently drying of the animal and inhibits the air apertures from becoming clogged after repeated use.

According to another aspect of the present disclosure, the air outlet ports are embedded within the bristles of the bristle base. The air outlet ports' location and shape leads to more efficiently drying of the animal and inhibits the air apertures from becoming clogged after repeated use.

According to another aspect of the present disclosure, the bristle base is detachable from the brush member. Being detachable enables a user to detach the bristle base and access the inside of the brush member. This is beneficial for cleaning the brush member. Also, being detachable enables the user to attach different bristle bases with different bristles onto the brush member. This is beneficial for using the apparatus on various animals with different skin, fur/hair types, or both.

According to another aspect of the invention, the handle member further includes a depressible prong and the brush member further includes a prong aperture. These structures enable a user to repeatably disconnect and reconnect the handle member and brush member. This is beneficial for giving a user access to the inside of the handle member and brush member, which enables better cleaning of the members. The disconnection also enables storage in smaller spaces.

According to another aspect of the present disclosure, the apparatus further includes a general air passageway; the general air passageway having at least one grill. The grill being beneficial for preventing matter from proceeding down the general air passageway.

Provided is a drying and brushing apparatus. The drying and brushing apparatus includes: a positive pressure air source; a tube connecting the positive pressure air source to a handle member; the handle member being connected to a brush member; the brush member further including a plurality of air apertures, a bristle base, and bristles. The air apertures include a series of air inlet ports and corresponding air outlet ports.

According to certain aspects of the present disclosure, the air outlet ports surround the perimeter of the bristle base.

According to further aspects of the present disclosure, the air outlet ports are embedded between the bristles of the bristle base.

According to further aspects of the present disclosure, a plurality of air outlet ports surround the bristle base, the air outlet ports are separated by divider sections, and the air outlet ports are surrounded by a hood which directs the flow of air downward.

According to further aspects of the present disclosure, a plurality of air outlet ports embedded between the bristles of the bristle base, the air outlet ports are separated by divider sections, and wherein the air outlet ports are surrounded by a hood which directs the flow of air downward.

According to further aspects of the present disclosure, the air apertures are substantially rectangular in shape.

According to further aspects of the present disclosure, the air apertures are substantially circular in shape.

According to further aspects of the present disclosure, the bristles may be made from metal, plastic, rubber, or a combination thereof.

According to further aspects of the present disclosure, the bristle base is detachable from the brush member.

According to further aspects of the present disclosure, the bristle base is detachably connected to the brush member, wherein four screws connect the bristle base to the brush member and are inserted within apertures at the corners of the bristle base to engage corresponding apertures within the brush member.

According to further aspects of the present disclosure, the handle member further includes a depressible prong mechanism and the brush member further comprises a prong aperture.

According to further aspects of the present disclosure, the apparatus is a non-human drying and brushing apparatus and the air aperture is not less than 0.25 inches wide as measured from a bristle base perimeter to a brush member edge.

According to further aspects of the present disclosure, the apparatus is a non-human drying and brushing apparatus having an air aperture that is circular in shape and a diameter that is not less than 0.25 inches.

According to further aspects of the present disclosure, the apparatus further includes a general air passageway, the general air passageway having at least one grill.

According to further aspects of the present disclosure, the handle member further includes a handle member air passageway and wherein the handle member air passageway further includes a grill.

According to further aspects of the present disclosure, the grill has slats that are no greater than 0.125 inches spaced apart from each other.

According to further aspects of the present disclosure, the brush member further includes a brush member front plate and a brush member back plate and wherein the brush member front plate is detachable from the brush member back plate.

Also provided is an apparatus for drying and brushing an animal. The apparatus includes: a positive pressure air source; a tube connecting the positive pressure air source to a handle member; the handle member being connected to a brush member; the brush member further comprising a plurality air apertures, a bristle base, and bristles; wherein the air apertures include a series of air inlet ports and corresponding air outlet ports, wherein the air outlet ports surround the bristle base, wherein the air outlet ports are substantially rectangular and wherein the air outlet ports are not less than 0.25 inches wide as measured from a bristle base perimeter to a brush member edge; wherein the bristle base is detachable from the brush member; wherein the handle member further comprises a depressible prong mechanism and the brush member further comprises a prong aperture; wherein the handle member further comprises a handle member air passageway and wherein the handle member air passageway further comprises a grill; and wherein the grill has slats that are no greater than 0.125 inches spaced apart from each other.

Also provided is an apparatus for drying and brushing an animal. The apparatus includes: a positive pressure air source; a tube connecting the positive pressure air source to a handle member; the handle member being connected to a brush member; the brush member further comprising a plurality of air apertures, a bristle base, and bristles; wherein the air apertures surround the bristle base, wherein the air apertures include a series of air inlet ports and air outlet ports, wherein the air outlet ports are substantially circular in shape and wherein the air outlet ports have a diameter of not less than 0.25 inches wide; wherein the bristle base is detachable from the brush member; wherein the handle member further comprises a depressible prong mechanism and the brush member further comprises a prong aperture; wherein the handle member further comprises a handle member air passageway and wherein the handle member air passageway further comprises a grill; and wherein the grill has slats that are no greater than 0.125 inches spaced apart from each other.

Also provided is a method for drying and brushing. The method includes the following steps: providing an apparatus including: i) a positive pressure air source; ii) a tube connecting the positive pressure air source to a handle member, the handle member being connected to a brush member and, the brush member further including a plurality of air apertures, a bristle base, and bristles; and drying and brushing an object by turning on the positive pressure air source and brushing the object with the brush member, wherein the air apertures include a series of air inlet ports and corresponding air outlet ports.

According to further aspects of the present disclosure of the method, the air outlet ports surround the bristle base.

According to further aspects of the present disclosure of the method, the air outlet ports are embedded between the bristles of the bristle base.

According to further aspects of the present disclosure of the method, the bristle base is detachable from the brush member.

According to further aspects of the present disclosure of the method, the air outlet ports are substantially rectangular in shape.

According to further aspects of the present disclosure of the method, the handle member further includes a depressible prong mechanism and the brush member further includes a prong aperture.

According to further aspects of the present disclosure of the method, the apparatus further includes a general air passageway, the general air passageway having at least one grill.

Other benefits and advantages of the present disclosure will become apparent to those skilled in the art to which it pertains upon reading and understanding of the following detailed specification.

### III. BRIEF DESCRIPTION OF THE DRAWINGS

The disclosed drying and brushing apparatus and method may take physical form in certain parts and arrangement of parts, embodiments of which will be described in detail in this specification and illustrated in the accompanying drawings which form a part hereof and wherein:

FIG. 1 is a view of a drying and brushing apparatus in accordance with an exemplary embodiment of the present disclosure.

FIG. 2 is a top view of handle and brush members of the drying and brushing apparatus in accordance with an exemplary embodiment of the present disclosure.

FIG. 3 is side view of the handle and brush members in accordance with an exemplary embodiment of the present disclosure.

FIG. 4 is side and perspective view of the brush member in accordance with an exemplary embodiment of the present disclosure.

FIG. 5 is a top sectional view of the brush member detached from the handle member in accordance with an exemplary embodiment of the present disclosure.

FIG. 6 is a view showing the grill in the handle member in accordance with an exemplary embodiment of the present disclosure.

FIG. 7 is a view showing a back side of a drying and brushing apparatus in accordance with an exemplary embodiment of the present disclosure.

FIG. 8 is a top cross sectional view of a back side of an exemplary brush member showing an arrangement of inlet air ports.

FIG. 9 is a view showing a drying and brushing apparatus in accordance with an exemplary embodiment of the present disclosure being used on recently washed dog.

FIG. 10 is a top view of handle and brush members of the drying and brushing apparatus in accordance with an alternative exemplary embodiment of the present disclosure.

FIG. 11 is side view of the handle and brush members in accordance with an alternative exemplary embodiment of the present disclosure.

FIG. 12 is side and perspective view of the brush member in accordance with an alternative exemplary embodiment of the present disclosure.

FIG. 13 is a top sectional view of the brush member detached from the handle member in accordance with an alternative exemplary embodiment of the present disclosure.

### IV. DETAILED DESCRIPTION

Referring now to the drawings wherein the showings are for purposes of illustrating embodiments of the article only and not for purposes of limiting the same, and wherein like reference numerals are understood to refer to like components.

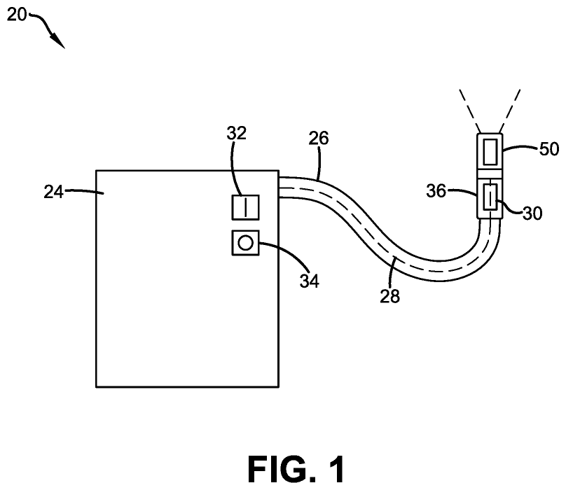

Referring to FIG. 1, an apparatus 20 is provided for brushing and drying. The apparatus 20 generally includes a positive pressure air source 24, a tube 26 connecting the positive pressure air source 20 to handle member 36. Attached to handle member 36 is a brush member 50. Tube 26 may be flexible. The positive pressure air source 24 may have an on switch 32 and an off switch 34, a single on/off switch or another means for actuating and ceasing operation of the positive pressure air source 24. The apparatus 20 also includes a heater 30. Heater 30 may be in the handle member 36 or in any other position within the apparatus 20 where it can heat air (e.g., the positive pressure air source 24, at any point along the tube 26, etc.). Heaters that can heat air and fit inside an apparatus are generally known, as disclosed in U.S. Pat. No. 4,023,578, which is incorporated herein by reference in its entirety.

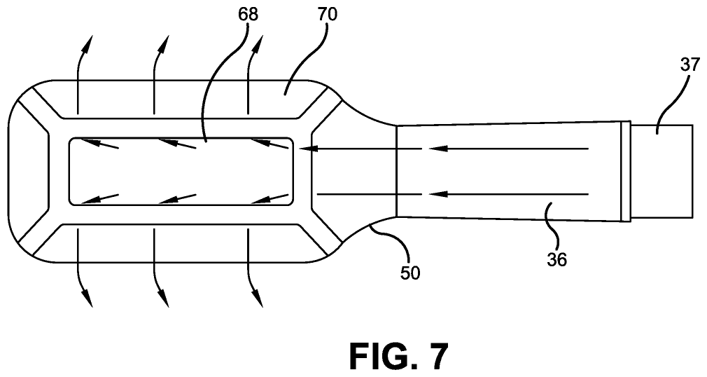

The air for drying the object flows as follows: from the positive pressure air source 24, through tube 26, through handle member air passageway 42 (which is inside handle member 36), through brush member air passageway 56 (which is inside brush member 50), and outlet air aperture 64. The path from the positive pressure air source 20 to the air aperture 64 is called general air passageway 28 herein. FIG. 1 shows the path air 28 during operation of the apparatus 20 (operation shown in FIG. 7).

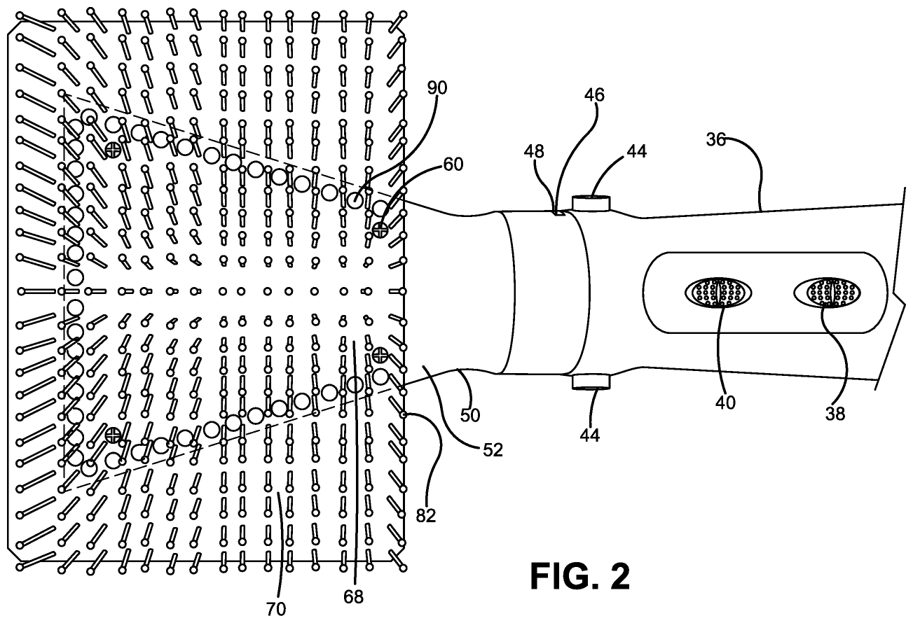

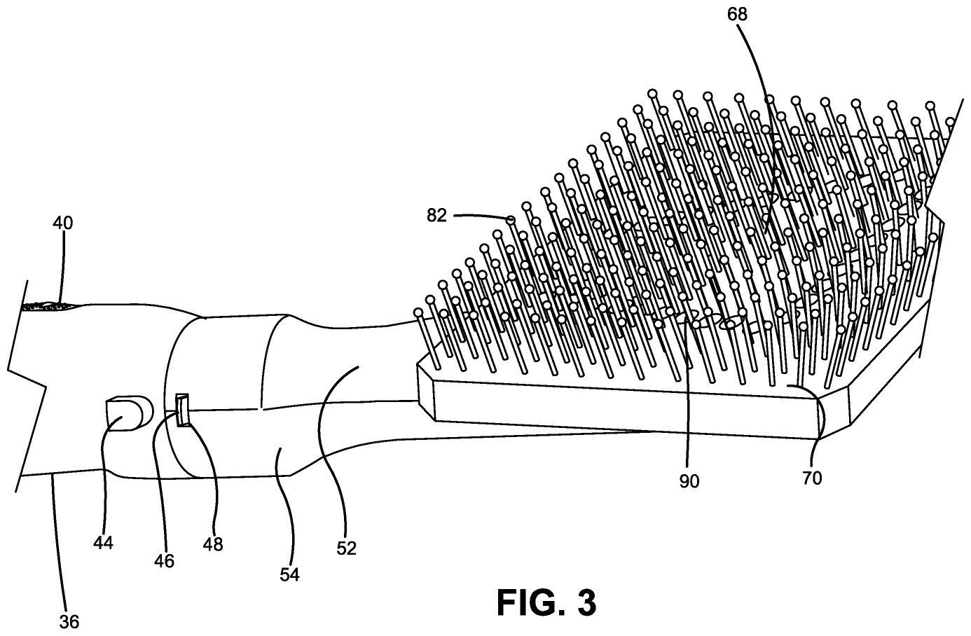

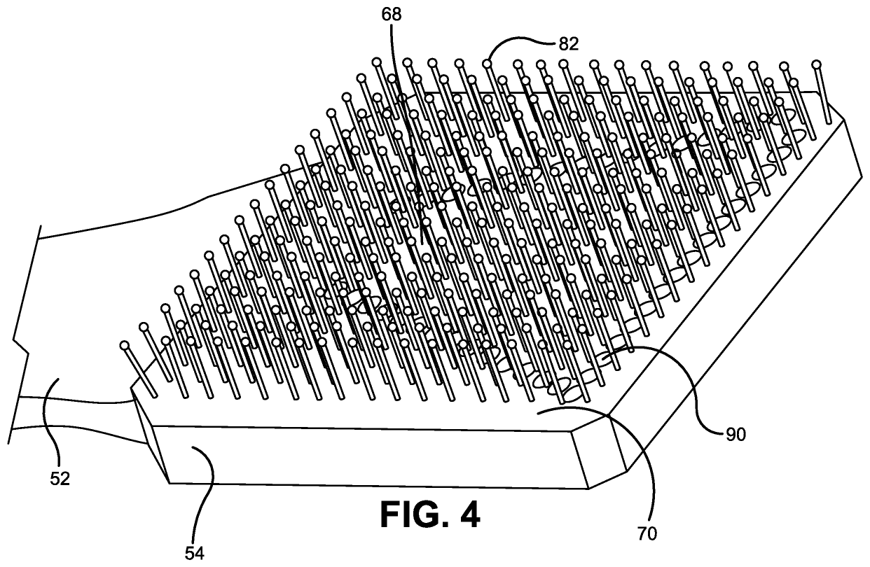

Now referring to FIGS. 2-4, handle member 36 further includes air flow adjuster 38. Air flow adjuster 38 controls the air flow generated by the positive pressure air source 24. A user can change press air flow adjuster 38 during use to adjust the air flow generated by the positive pressure air source 24.

Handle member 36 further includes heater adjuster 40. Heater adjuster 40 controls the amount of heat generated by the heater 30. A user can press heater adjuster 40 during use to adjust the amount or level of heat generated by the heater 30.

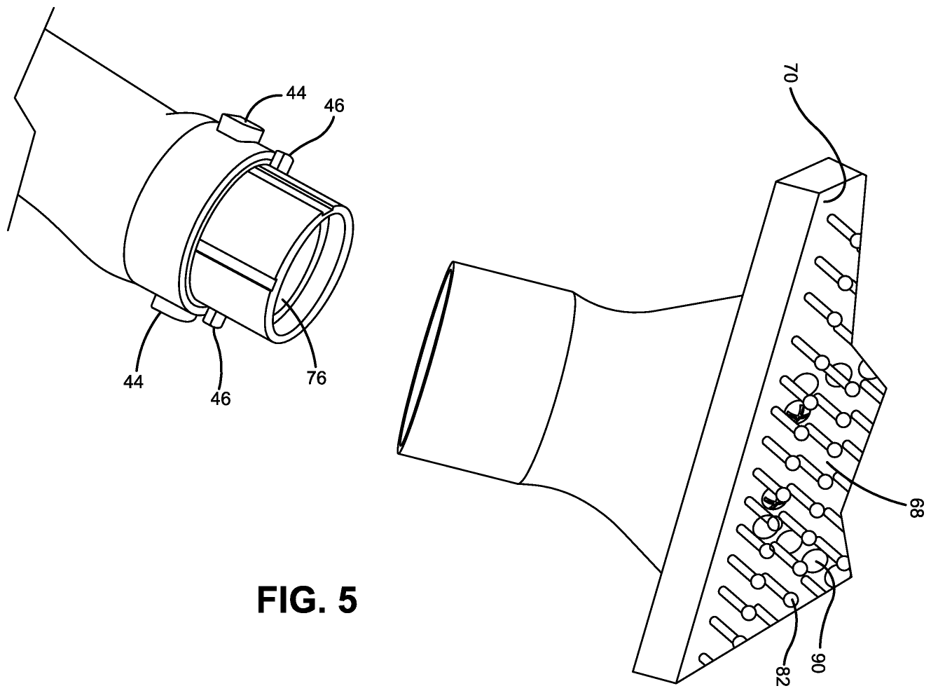

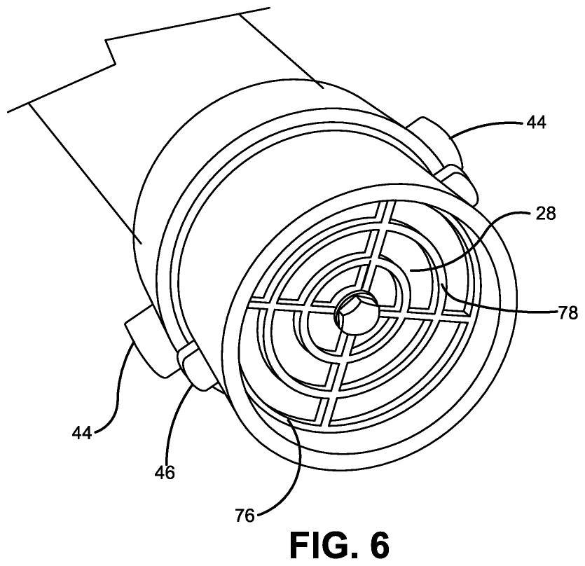

Referring now to FIGS. 2-6, handle member 36 further includes depressible prong mechanism 44 protruding out of the side of handle member 36. Depressible prong mechanism 44 is connected to prong 46 (FIG. 6 shows this best). In one aspect of this disclosure, depressible prong mechanism 44 is a button. When a user presses depressible prong mechanism 44, prong 46 is also depressed allowing for release of the brush member 50 from the handle member 36. In one aspect of this disclosure, handle member 36 has two depressible prong mechanism 44 prong 46 sets (as shown in FIG. 5); in other aspects, only one set.

In one aspect of the present disclosure, brush member 50 includes prong aperture 48. Depressible prong mechanism 44, prong 46, and prong aperture 48 allow repeated connection and disconnection of handle member 36 and brush member 50. In this aspect, prong 46 fits into prong aperture 48 so that handle member 36 and brush member 50 are held together snugly and connected together. When a user wants to disconnect handle member 36 and brush member 50, the user presses down on depressible prong mechanism 44. This causes prong 46 to depress. Afterward, prong 46 is not longer inside prong aperture 48 and the user can urge apart handle member 36 and brush member 50. To reconnect handle member 36 and brush member 50, a user can repeat the same disconnect process but instead urge handle member 36 and brush 50 together. In addition, prong 46 may be shaped so that in order to reconnect handle member 36 and brush member 50, the user does not need to press depressible prong mechanism 44. In this aspect, the prong 46 may be wedge shaped. When it is shaped so that the user does not need to press depressible prong mechanism 44, the user may just urge handle member 36 and brush member 50 together to reconnect them. During this action, brush member 50 depresses prong 46 until prong 46 slips through prong aperture 48. FIG. 6 shows best the wedge shape of prong 46 that allows this reconnecting function. There are many benefits of having a handle member 36 and a brush member 50 which are capable of being repeatedly disconnected and reconnected. First, by being able to disconnect the two members, a user can get access to the interior areas of the components, check and clean out blockages, and wipe down their inside faces. Furthermore, disconnecting allows easier storage of the brush member 50. In certain embodiments where a grill 76 is located in a brush member air passageway 56, disconnection allows access to the grill 76 to clean it or remove air passageway blockages. Grill 76 is discussed in greater detail below.

In one aspect of the present disclosure, brush member 50 includes brush member front plate 52 and brush member back plate 54. In this aspect, brush member front plate 52 and brush member back plate 54 fit together to form the outside of brush member 50. In one aspect, bristle base 68 is attached to the brush member front plate 52. In this aspect, a user can remove brush member front plate 52 and bristle base 68 by detaching them. In one aspect of the present disclosure, this is done by removing screw 60 located at various positions along the bristle member front plate 52.

In one aspect of this disclosure, removing screw 60 detaches brush member front plate 52 from brush member back plate 54. In this aspect, removal of screws 60 fully exposes air aperture 64 and bristle base 68. Full exposure allows the user to efficiently clean and remove debris obstructing air aperture 64 and bristle base 68, yielding more effective drying and grooming.

More than one screw 60 may be used to fasten bristle base 68 to brush member 50. For example, FIG. 2 shows four screws, however, any number of screws may be used. The additional screw(s) 60 ensure a close-fitting seal between bristle base 68 and brush member 50, effectively allowing uniform heat from air aperture 64 and enhanced sturdiness in the bristle base 68.

Referring to FIGS. 1 and 6, a general air passageway 28 is contained within tube 26, handle member 36, and brush member 50. Positive pressure air source 24 supplies air along the general air passageway 28, exiting through air aperture 64. The general air passageway 28 contains at least one grill 76, positioned within handle member 36 (as shown in FIG. 6). Pressing down on depressible prong mechanism 44 depresses prong 46 allowing for separation of brush member 50 from handle member 36. Separating brush member 50 from handle member 36 reveals grill 76. The slatted 78 grill 76 prevents large debris and matter from continuing along general air passageway 28.

FIG. 7 is a diagram showing the flow of air from a back side perspective of an exemplary drying and brushing apparatus 20. Although the back side of the drying and brushing apparatus 20 is shown with a certain shape, it is understood that the drying and brushing apparatus may have any shape within the purview of a person of ordinary skill in the art. As shown in FIG. 7, the collar 37 may have a diameter opening that is slightly smaller than the diameter opening of the handle member 36 and the diameter opening of tube 26 for engaging the handle member 36 to the end of tube 26. According to certain aspects of the present teaching, the collar 37 has a length of 1 inch or about 1 inch. However, it is to be understood that the collar 37 may have any length and any diameter as may be deemed suitable by a person of ordinary skill in the art. According to further aspects of the present teaching, the overall length of the handle member 36, bristle base 68, brush member 50 and collar 37 is 9.75 inches or about 9.75 inches.

However, it is to be understood that the overall length of the handle 36, bristle base 68, brush member 50 and collar 37 may be any length as deemed suitable by a person of ordinary skill in the art. As further shown within FIG. 7, air flow flows enters the collar 37 from the tube 26 and flows through the handle member 36 to the air apertures 64 (not shown) within the bristle base. It is noted that brush member 50 tapers outward or expands in diameter from the handle member 36 forming a periphery around air apertures 64 (located opposite the rectangular shape within the bristle base 68). This periphery acts as a hood 70 which directs and provides for a downward flow of air from the air apertures onto the animal.

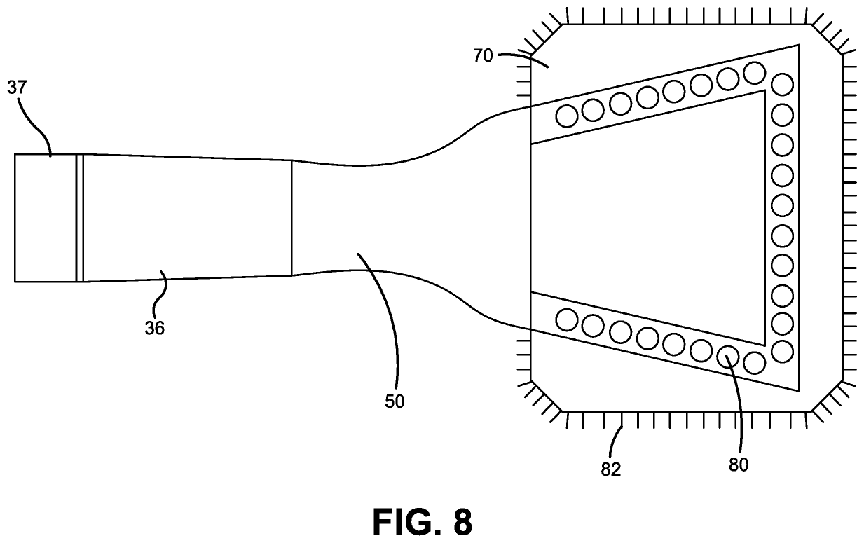

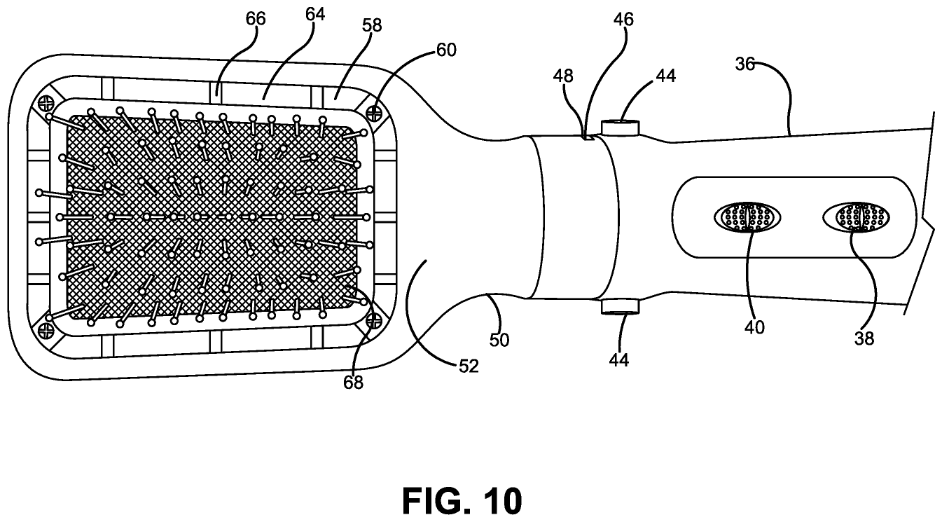

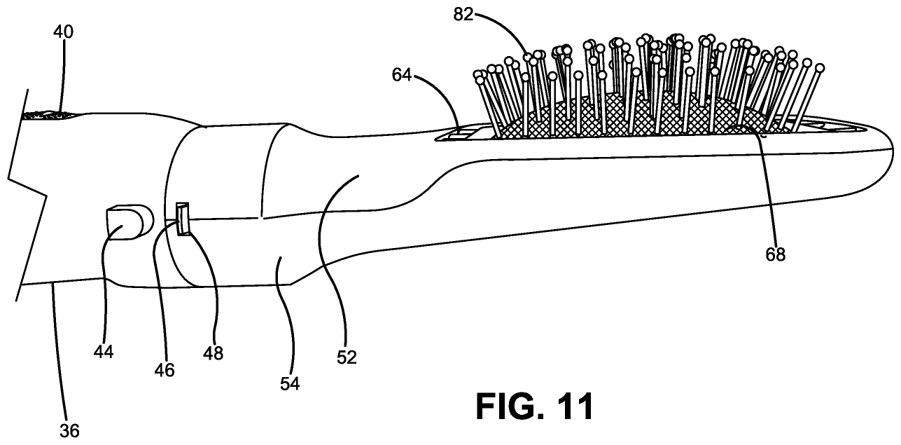

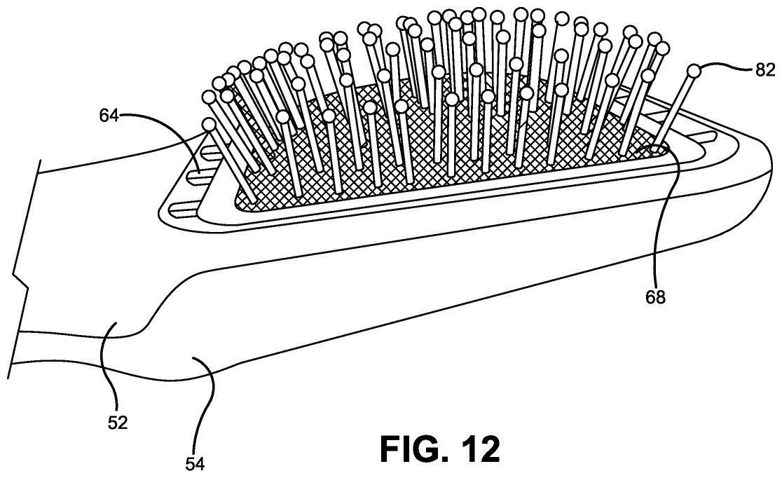

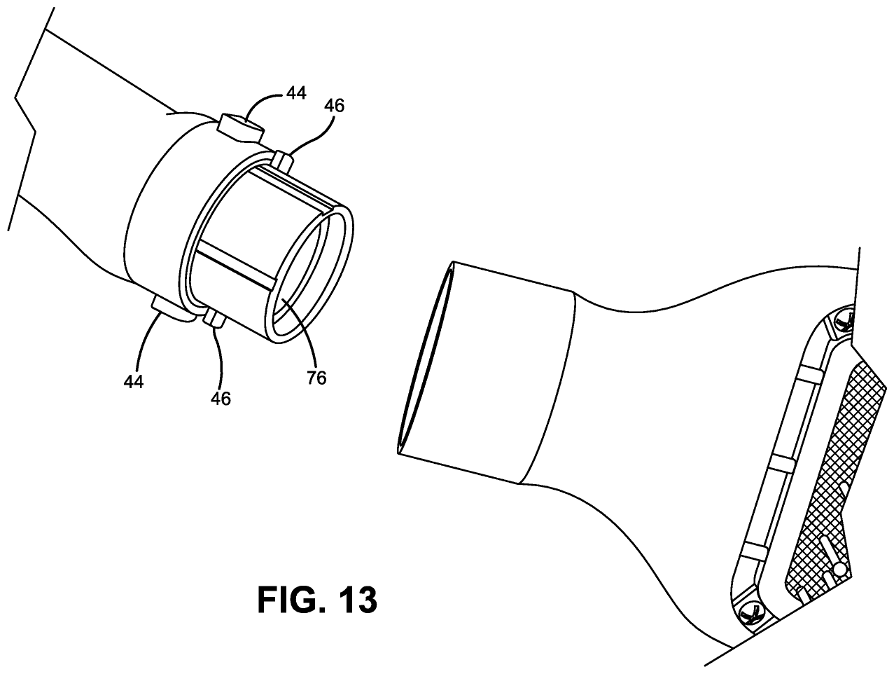

FIG. 8 illustrates a cross sectional top view of back side of an exemplary brush member. As shown within FIG. 8, air inlet ports 80 are arranged within a channel that allows for the passage of air within the bristle base 68. The air inlet ports 80 shown in this Figure are arranged in a first row, a second row and a third row within the channel. Two of the air inlet port rows shown in FIG. 8 are arranged in a non-parallel manner. However, it is to be understood at two air inlet port rows may also be arranged in a parallel manner. FIG. 8 further illustrates that two air inlet rows may be positioned at an acute inner angle with respect to a third row at two respective intersection points. However, in other embodiments, the two air inlet rows may be positioned at an obtuse inner angle or a right angle with respect to the third row at the two respective intersection points. Although a certain number of air inlet ports are illustrated within FIG. 8, it is to be further understood that any number of air inlet ports may be arranged within the air inlet port channel. Hood 70 shown within FIG. 8 is formed by the peripheral area outside the air inlet port channel and acts to direct and provide for a downward flow of air from air inlet ports on the front side of the brush member. This arrangement of air inlet ports 80 results in the corresponding air outlet ports 90 on the front plate 52 being positioned within the bristle base 68 between bristles 82, that is, between the body of bristles 82 within bristle base 68. In an alternative embodiment, air outlet ports may be positioned outside of the bristle base 68. An example of such an embodiment is provided in FIGS. 10-13, which illustrate air outlet ports 64 formed within the body of the front plate 52 and positioned along the outside perimeter of the bristle base 68. Air outlet ports 64 may be further separated by air outlet port dividers 66 along the outside perimeter of the bristle base. In certain embodiments, screw plate 58 and screw 60 may secure a structure forming the air outlet ports 64 and air outlet port dividers 66 along the perimeter of the bristle base 68.

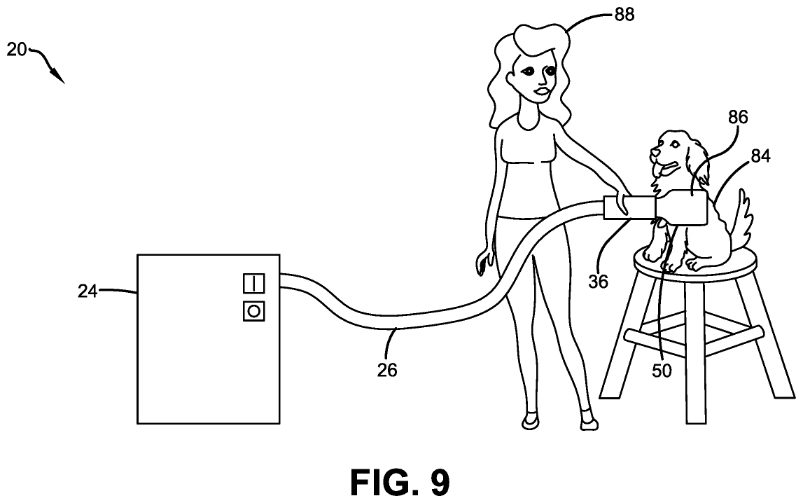

Now referring to FIG. 9, the apparatus 20 may be used on an animal such as a dog 84 with fur 86. A human 88 can apply apparatus 20, comprising a positive pressure air source 24, a tube 26, a handle member 36, and a brush member 50, to an object such as a dog 84 with fur 86 to perform simultaneous bushing and drying.

Numerous embodiments have been described herein. It will be apparent to those skilled in the art that the above apparatus and methods may incorporate changes and modifications without departing from the general scope of this invention. It is intended to include all such modifications and alterations in so far as they come within the scope of the apparatus and methods set forth in the appended claims or the equivalents thereof. The phrase “associated with” as used in this document, refers to structures which support the disclosed apparatus and methods and may also refer to structures not disclosed herein capable of supporting the disclosed apparatus and methods. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. A drying and brushing apparatus comprising:
a positive pressure air source and a tube connecting the positive pressure air source to a handle member, wherein the handle member is connected to a brush member, wherein the brush member further comprises air apertures, a bristle base, and bristles, and wherein the air apertures comprise a series of air inlet ports and corresponding air outlet ports.

2. The apparatus of claim 1, wherein the air outlet ports are embedded within the bristles of the bristle base or surround the perimeter of the bristle base.

3. The apparatus of claim 1, wherein the air outlet ports are embedded within the bristles of the bristle base, wherein the air outlet ports are separated by divider sections and wherein the air outlet ports are surrounded by a hood which directs the flow of air downward.

4. The apparatus of claim 2, wherein the air outlet ports are circular in shape.

5. The apparatus of claim 1, wherein the bristles comprise metal, plastic, rubber, or a combination thereof.

6. The apparatus of claim 1, wherein the bristle base is detachable from the brush member.

7. The apparatus of claim 1, wherein the bristle base is detachably connected to the brush member, wherein four screws connect the bristle base to the brush member and are inserted within apertures at the corners of the bristle base to engage corresponding apertures within the brush member.

8. The apparatus of claim 1, wherein the handle member further comprises a depressible prong mechanism and the brush member further comprises a prong aperture.

9. The apparatus of claim 2, wherein the apparatus is a non-human drying and brushing apparatus and the air aperture is not less than 0.25 inches wide as measured from a bristle base perimeter to a brush member edge.

10. The apparatus of claim 1, wherein the apparatus further comprises a general air passageway, the general air passageway having at least one grill.

11. The apparatus of claim 1, wherein the handle member further comprises a handle member air passageway and wherein the handle member air passageway further comprises a grill.

12. The apparatus of claim 10, wherein the grill has slats that are no greater than 0.125 inches spaced apart from each other.

13. The apparatus of claim 1, wherein the brush member further comprises a brush member front plate and a brush member back plate and wherein the brush member front plate is detachable from the brush member back plate.

14. An apparatus for drying and brushing an animal comprising:
i. a positive pressure air source;
ii. a tube connecting the positive pressure air source to a handle member;
iii. a brush member connected to the handle member;
iv. the brush member comprising a plurality of air apertures, a bristle base, and bristles, wherein the air apertures comprise a series of air inlet ports and air outlet ports;
v. wherein the air outlet ports are embedded between the bristles of the bristle base, wherein the air outlet ports are substantially circular in shape and wherein the air outlet ports are not less than 0.25 inches in diameter;
vi. wherein the bristle base is detachable from the brush member;
vii. wherein the handle member further comprises a depressible prong mechanism and the brush member further comprises a prong aperture;
viii. wherein the handle member further comprises a handle member air passageway and wherein the handle member air passageway further comprises a grill; and wherein the grill has slats that are no greater than 0.125 inches spaced apart from each other.

15. A method for drying and brushing comprising:
i. providing an apparatus comprising:
1. a positive pressure air source;
2. a tube connecting the positive pressure air source to a handle member;
3. a brush member connected to the handle member;
4. the brush member further comprising a plurality of air apertures, a bristle base, and bristles, wherein the air apertures comprise a series of air inlet ports and corresponding air outlet ports;
ii. drying and brushing an object by turning on the positive pressure air source and brushing the object with the brush member.

16. The method of claim 15, wherein the air outlet ports are embedded between the bristles of the bristle base.

17. The method of claim 15, wherein the bristle base is detachable from the brush member.

18. The method of claim 16, wherein the air apertures are substantially circular in shape.

19. The method of claim 15, wherein the handle member further comprises a depressible prong mechanism and the brush member further comprises a prong aperture.

20. The method of claim 15, wherein the apparatus further comprises a general air passageway, the general air passageway having at least one grill.
